(19) United States
(12) Patent Application Publication
(10) Pub. No.: US 2007/0133693 A1
(43) Pub. Date: Jun. 14, 2007

(54) Method and system for extracting/storing specific program from mpeg multpile program tranport stream

(75) Inventors: Liang Gan, Shanghai (CN); Jingwei Tan, Shanghai (CN); Jun Shi, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V., Eindhoven (NL)

(21) Appl. No.: 10/578,065

(22) PCT Filed: Nov. 3, 2004
(86) PCT No.: PCT/IB04/52274

§ 371 Date: May 2, 2006

(30) Foreign Application Priority Data
Nov. 6, 2003 (CN) 200310114245.9

(51) Int. Cl. H04N 11/04; H04N 7/12

(52) U.S. Cl. 375/240.26

(57) ABSTRACT

This invention provides an improved method for storing/replaying a specific program from a MPEG-2 multiple program transport stream. When storing, the method discards a related transport packet of the non-user-selected program and inserts a null packet at the corresponding discarding position, and the effective load of this null packet contains a number which indicates the number of continuously discarded packets at this position; when replaying, if the effective load of a null packet contains a specific numerical value, the method adds some null packets beside this null packet, the number of the added null packets being equal to that the specific numerical value minus one.

### BACKGROUND ART

The present invention relates to an MPEG (Motion Picture Expert Group) transport stream, particularly to a method and system for extracting/storing specific program from MPEG-2 multiple program transport stream.

MPEG-2 standard (ISO/IEC 13818-1) is a standard for providing digital data stream to digital devices, such as Set Top Box (STB), digital TV (DTV), interactive devices, etc.

FIG. 1 is a conventional process of generating multiple program MPEG-2 transport stream. The video signal and audio signal of each program are respectively compressed into video elementary stream (ES) and audio elementary stream (ES) according to preset algorithm after being received by video encoder 112 and audio encoder 114; these elementary steams and data like Teletext, close caption, etc. are respectively converted into video PES (packetized elementary stream), audio PES and data PES by the packetizer 118 under the control of the Program Clock Reference (PCR) sent by the clock means 130; these PES and private sections compose all the contents of said program. The content groups of a plurality of programs and the program specific information sections (PSI) are input into a multiplexer 140 to be multiplexed and then a standard multiple program MPEG-2 transport stream (TS) is output, which is composed of a number of transport packets. The PSI section may include program associated table (PAT) and program mapping table (PMT), etc.

FIG. 2 is a schematic drawing of the flow of converting an elementary stream into TS packets. The elementary stream 210 is decomposed into a group of PES payload 224 by the packetizer, and a PES header 222 is added before each payload to form a group of PES packets 220. The combination of payloads of said group of PES packets corresponds to an elementary stream.

After being processed by the multiplexer, each PES packet 220 turns to be a TS packet 230 of 188 bytes, which conforms to the MPEG standard, and each TS packet includes a TS header 232 (TS Header) of four bytes and a TS payload 234 of 184 bytes. The combination of said group of transport packets corresponds to a PES packet 220. If the TS header contains program transport stream, first, at stage one, find the PAT from the payload of the TS packet whose packet identification (PID) equals to 0x0000 (step S310); second, the packet identification PMT PID of the transport packet which includes the program mapping table (step S320) is acquired from the program associated table PAT, according to the program selecting information (i.e., program identification) sent by the user; subsequently, at stage two, it finds the transport packets containing program mapping table according to the PMT PID, so as to obtain the program mapping table PMT (step S330); then the packet identification of the transport packet associated with the selected program is obtained from the program mapping table PMT and the special packet identification prescribed by standard (step S340), including the PID of the transport packet containing the elementary stream content, the PID of the transport packet containing the program specific information/service information (PSI/Si) of specific program, and the PID of the transport packet containing the program clock reference (PCR); finally, at stage three, comparing the received PID value of the transport packet with the above-mentioned PID values, if it is one of said PID values, it will be sent to the next step to be processed; otherwise, said transport packet will be discarded (step S350).

There are mainly the following two kinds of methods of extracting/storing specific program from MPEG-2 multiple program transport stream currently:

In the first one, the bit rate of the transport packet processed by the flow as shown in FIG. 3 is adjusted by the transcoder, and then re-multiplexed to obtain a new transport stream containing specific program that conforms to MPEG-2 standard for further process, such as transferring or storing. The defect of said method is that transcoding/re-multiplexing will increase the cost.

In the second one, an arrive time clock (ATC) tag is added to the transport packet obtained from the flow in FIG. 3 to generate a partial transport stream, then further process, such as transferring or storing, is performed during replay, by using the arrive time clock as reference, all the transport packets are provided according to their arrive time for further process. The defect of said method is that the process of replay is complex, in addition, since the arrive time clock ATC tag is not a part of MPEG-2 standard, further processing, such as edit, to said stream files becomes complex.

Meanwhile, the partial transport stream generated by said method only includes the selection information table (SIT) and the discontinuity information table (DIT), while according to its grammar, other service tables (Si table), which are necessary for the interactive TV, will not be provided any more.

The transport stream compatible with MHP (Multimedia Home Platform) standard is a transport stream, which is based on the MPEG-2 standard but has more robust functions. If a transport compatible with MHP standard is processed in accordance with the above -mentioned two methods, the new program transport stream generated will not conform to MHP standard.

Therefore, there is a need to provide a method for extracting/storing specific program from an MPEG-2 multiple program transport stream, which method may ensure that the newly generated program transport stream may maintain the bit rate during transportation and may still be compatible with the MPEG-2 standard during replay.

### CONTENT OF INVENTION

The present invention provides an improved method for extracting specific program from an MPEG-2 multiple program transport stream, and the packet identification (PID) value of the transport packet in the program transport stream is significant to the present invention. After receiving a multiple program transport stream and the user selecting information for the specific program, all the packet identifications (PIDs) of the transport packets associated with the selected program are obtained from the program associated table (PAT) of the specific program selected by the user, then the packet identifications of each transport packet received are compared with the above-mentioned packet identifications, if they are consistent, said transport packet will not be processed and will be directly transported to the newly generated program transport stream; if they are inconsistent, the packet identification (PID) of said transport packet will be set as 0x1FFF, and then be transported to the newly generated program transport stream.

The program transport stream generated by said method conforms to the MPEG-2 standard and may keep the bit rate unchanged during transportation. If the original transport stream conforms to the MHP standard, the new transport stream still conforms to MHP standard. In addition, this method requires no additional transcoder and remultiplexer, that is, it does not need additional processes of transcoding and re-multiplexing.

The present invention also provides an improved method for storing/replaying specific program from a MPEG-2 multiple program transport stream. During storing, after a multiple program transport stream and the user selecting information for the specific program are received, all the packet identifications (PID) of the transport packets associated with the selected program are obtained from the program associated table (PAT) of the specific program selected by the user, then the packet identification of each transport packet received are compared with the above-mentioned packet identifications. If they are consistent, said transport packet will not be processed and will be stored into a specified medium; if they are inconsistent, said transport packet will be discarded and a null packet is stored at said discarding position, the payload of the null packet contains numerical value 1; if a plurality of packets are discarded continuously, only one null packet is stored, whose payload contains the number of transport packets that are continuously discarded at said position; finally, a mark of discarding packet is stored in a program information file on said storage medium, said mark is used to indicate that packet discarding has been carried out on said program.

During replay, first the program information file stored on said storage medium is read out, and it is determined that if said program information file has packet discarding mark; if it has, read all the transport packets of said program from said storage medium and judge the packet identification (PID) of each transport packet; if the PID does not equal to 0x1FFF, send said transport packet to the next step of processing; if the PID equals to 0x1FFF, said transport packet is null packet and then a value is obtained from the payload of said null packet and the null packets of the number of said numerical value minus 1 are added beside said null packet, subsequently, said null packets are sent to the next step of processing.

Said method of storing/replaying specific program may save a great amount of storage space during storing; and during replay, the program is read and processed but still conforms to the MPEG-2 standard; besides, if the original transport stream satisfies MHP standard, the new transport stream that is read out still conforms to MHP standard. In addition, the present method does not need any additional transcoder and re-multiplexer, that is, it does not need additional processes of transcoding and re-multiplexing.

Other objects and advantages together with a further understanding of the invention will become apparent and appreciated by referring to the following description and claims taken in conjunction with the accompanying drawings.

### DESCRIPTION OF FIGURES

The present invention is explained in detail with reference to the figures by way of embodiments, wherein,

FIG. 1 is a conventional process of generating multiple program MPEG-2 transport stream;

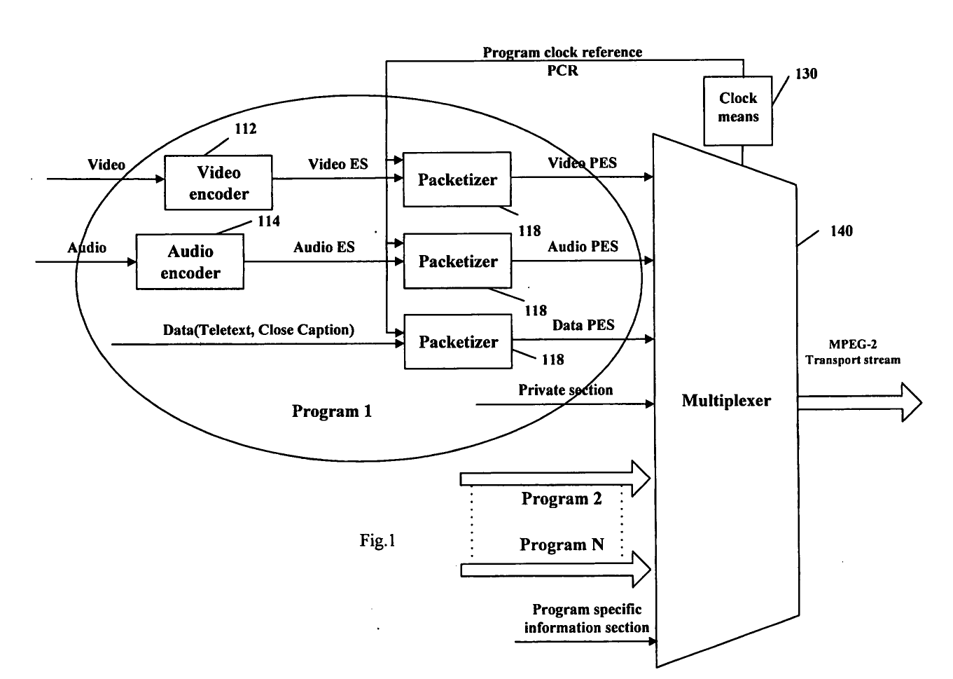

FIG. 2 is a schematic drawing of the flow of converting an elementary stream ES into transport packet (TS packet);

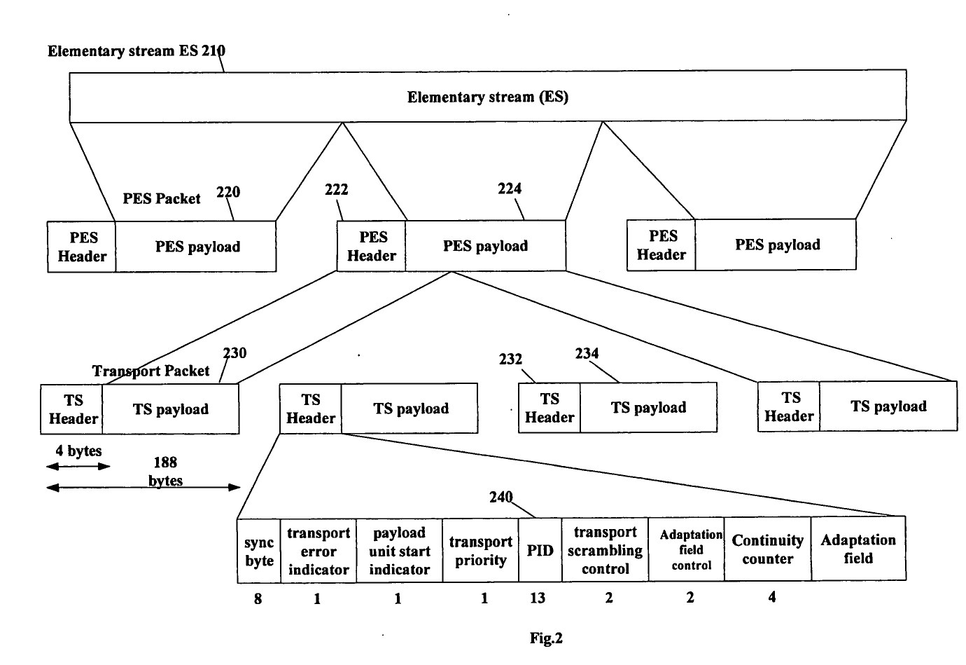

FIG. 3 is a schematic drawing of the flow of identifying specific program from a program transport stream;

FIG. 4 is a schematic drawing of the system of extracting specific program from an MPEG-2 multiple program transport stream according to an embodiment of the present invention;

FIG. 5 is a schematic drawing of the flow of extracting specific program from an MPEG-2 multiple program transport stream according to an embodiment of the present invention;

FIG. 6 is a schematic drawing of the system of storing/replaying specific program from an MPEG-2 multiple program transport stream according to another embodiment of the present invention;

FIG. 7 is a schematic drawing of the flow of storing specific program from an MPEG-2 multiple program transport stream according to another embodiment of the present invention;

FIG. 8 is a schematic drawing of the flow of replaying the specific program stored according to the present invention according to another embodiment of the present invention;

In all the figures, the same reference numerals indicate the same or similar features and functions.

### SPECIFIC EMBODIMENTS

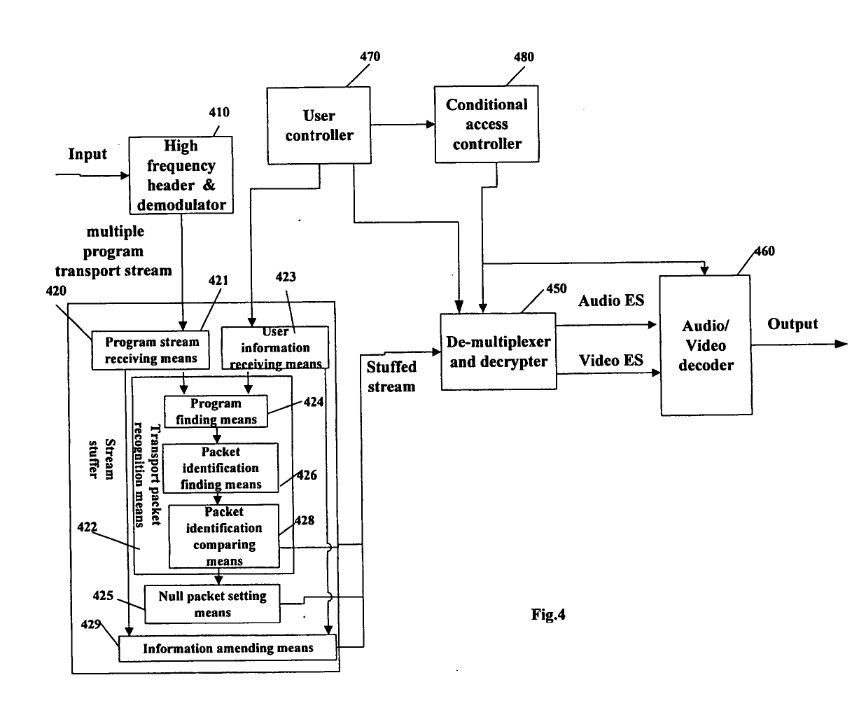

FIG. 4 is a schematic drawing of the system of extracting specific program from an MPEG-2 multiple program transport stream according to an embodiment of the present invention. Said system may be used as a part of the program receiving means of the user, such as the set top box. A receiving means 410, such as a high frequency header and demodulator, as shown in the figure is used to receive an input signal and output a digital program transport stream, which is a multiple program transport stream. If a multiple program transport stream is provided thereto directly, said high frequency header and demodulator 410 will not be needed any more.

The user sends a signal for selecting specific program to the stream stuffer 420 through the user controller 470, the packet identification of the transport packet associated to the non-user-selected program is set by the stream stuffer 420 as 0x1FFF and is then output together with the transport packets associated with the program selected by the user, as the stuffed transport stream. If there is one specific program selected by the user, the corresponding stuffed transport stream is a single program transport stream; if there are a plurality of programs selected by the user, the corresponding stuffed transport stream is a multiple program transport stream. The specific stuffing process of the stream stuffer will be described later.

Said stream stuffer 420 comprises a program stream receiving means 421, for receiving a multiple program transport stream from the high frequency header and the demodulator 410, said transport stream comprises transport packets; a user information receiving means 423 for receiving the user selecting information for the specific program contained in said multiple program transport stream by the user controller 470; a transport packet identifying means 422 for finding the transport packet of programs that are not selected by the user from said multiple program transport stream, according to the user selecting information for said specific program; and a null packet setting means 425, for setting the packet identification (PID) of the transport packet of the non-user-selected program to be a specific numerical value, such as 0x1FFF and said specific numerical value is a null packet identification, meanwhile, the set transport packet together with the transport packet of the program selected by the user are sent to the next step of processing in the order of original transport stream.

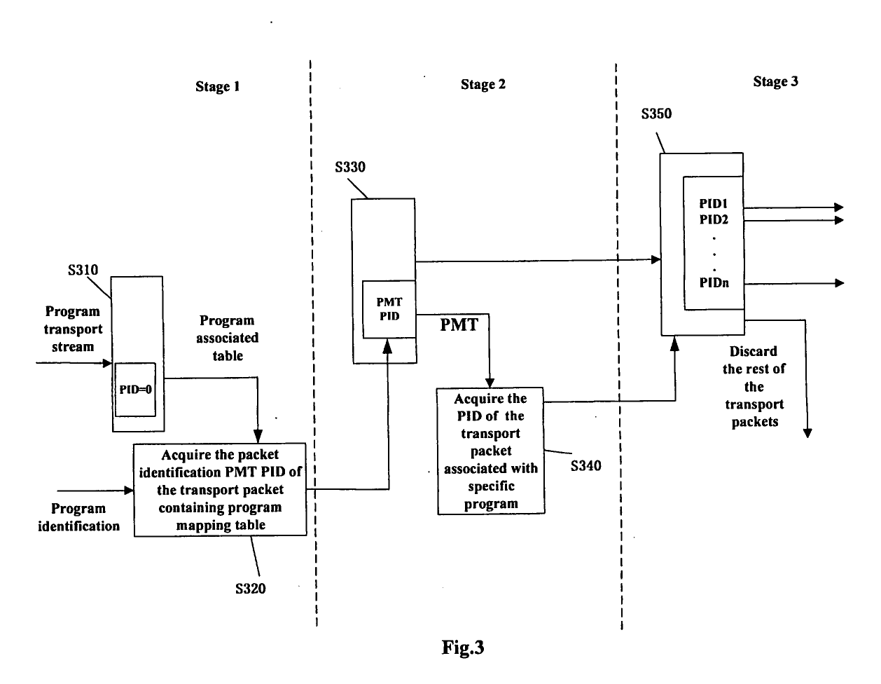

Said transport packet identifying means 422 further comprises a program finding means 424 for finding the packet identification (PID) of the associated transport packet from the program associated table (PAT), according to the user selecting information for the specific program, the payload of said transport packet includes the program mapping table (PMT) of the selected program; a packet identification finding means 426 for finding the packet identification (PID) of the transport packet associated with the selected program from the program associated table (PAT) and creating a packet identification list of the program selected by the user; and a packet identification comparing means 428 for comparing the packet identification (PID) of the received transport packet with the packet identification (PID) in the packet identification list of the program selected by the user, to find the transport packet of the non-user-selected program and send the transport packet of program that is selected by the user to the next step of processing. Said three means connected together may implement the processing flow as shown in FIG. 3.

Said stream stuffer 420 may further comprise an information amending means 429 for amending the program relation list of said multiple program transport stream according to the user selecting information for specific program.

Said stuffed transport stream conforms to the MPEG-2 standard and may be used in further processing, such as transferring, storing and playing, and may keep the bit rate unchanged during transferring; if the original transport stream conforms to the MHP standard, the new transport stream still conforms to the MHP standard. Said stuffing function allows the user to extract programs that he likes from the multiple program stream conveniently, and transfer it to share with others without the remultiplexer. When the others receive said stuffed stream, they may play it with the current media player.

If said stuffed transport stream is used for play, the subsequent play process would be the same as that of the prior art. The stuffed transport stream is sent to the de-multiplexer and decrypter 450, and one of the functions of said de-multiplexer and decrypter 450 is to demultiplex the transport stream into the program elementary stream. If the transport stream is a multiple program transport stream, a program transport stream will be selected and de-multiplexed into program elementary stream, according to the program selection control signal sent from the user through the user controller 470. Said program elementary stream is decoded by the audio/video decoder 460 to become audio/video signal for playing. Another function of said de-multiplexer and decrypter 450 is to decrypt the program according to the storage control signal sent from the condition al access controller 480, to be processed by the audio/video decoder 460.

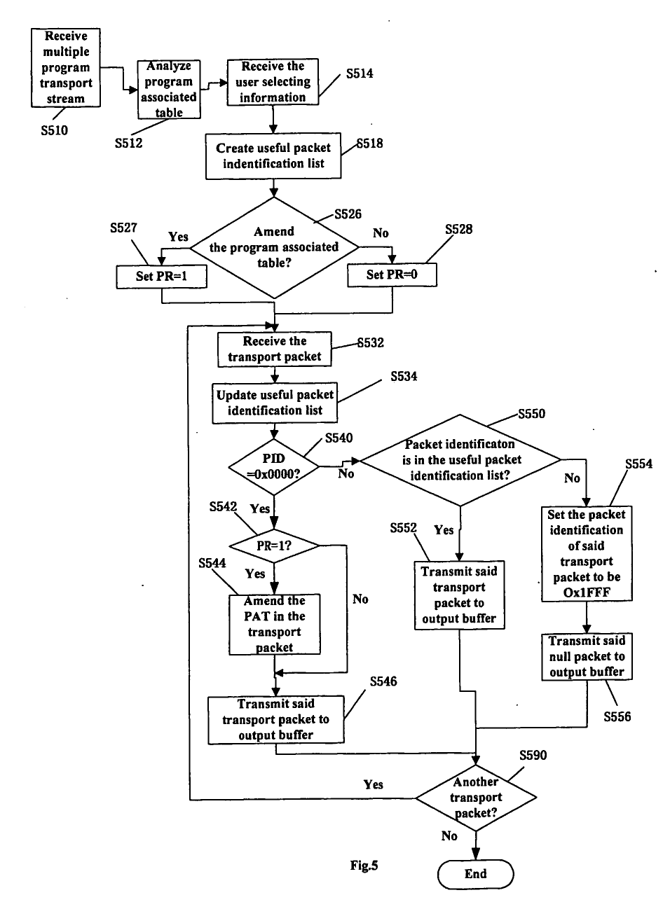

FIG. 5 is a schematic drawing of the flow of extracting specific program from an MPEG-2 multiple program transport stream according to an embodiment of the present invention. Said flow is the specific stuffing flow of the stream stuffer 420 as shown in FIG. 4. Firstly, it starts to receive a multiple program transport stream (step S510), the program associated table (PAT) is analyzed (step S512), the information of the user' selection of specific program is received and found (step S514), according to said selection information, the packet identifications of all the transport packet associated with said specific program are obtained from the program mapping table (PMT) and standard prescribed special PID numerical value, so as to create a packet identification list of the program selected by the user, namely, the useful packet identification list (step S518). Meanwhile, it may be decided if the program associated table should be modified according to the user's selection (step S526); if it is amended (step S527), set parameter PR=1; if it is not amended (step S528), set parameter PR=0. However, said step may not be carried out, and accordingly, the following described step S524 will also not exist.

Said useful packet identification list corresponds to the transport packet including all of the program specific information/service information table (PSI/SI) with the specific program selected by the user, to all the transport packet containing the audio/video elementary stream data of the specific program selected by the user, and to all the transport packet of the program clock reference containing the specific program selected by the user. In MPEG-2 standard, PSI/SI table includes the program associated table (PAT), program mapping table (PMT), network information table (NIT), conditional access table (CAT), service description table (SDT), discontinuity information table (DIT) and event information table (EIT).

Said list may also correspond to the transport packet including the information tables conforming to the MHP standard, and these special information tables include running status table (RST), time offset table (TOT), stuffing table (ST) and a bouquet information table (BAT), etc.

Then it starts to receive the transport packet (step S532). If the program transport stream has been adjusted during transportation, such as changing from four-program transport stream into three-program transport stream, the useful packet identification list will have to be updated (step S534); if the program transport stream has not been adjusted during transportation, said step may be omitted.

If the packet identification of the received transport packet equals to 0x1111, then said transport packet includes program associated table (PAT) (step S540), next, it is further judged that if parameter PR equals to 1 (step S542), if parameter PR equals to 1, an information amending means will amend the program associated table in the payload of said transport packet according to the user selecting information for specific program (step S544), so that the transport stream of the generated new program transport steam may only reflect the selected specific program, and said amending process is illustrated in the following; send the amended transport packet to the output buffer (step S5460) to detect if there is another transport packet to be processed (step S590). If the parameter PR does not equal to 1, it is judged that if there is another transport packet to be processed (step S590) after directly sending said transport packet to the output buffer (step S546), and under such circumstance, when displaying said program transport stream, the color of the title of the un-selectable program may be set to be dark color at the application level, so as to enable the user to learn that the original program transport stream contains said un-selectable program.

If the packet identification of the received transport packet does not equal to 0x0000 (step S540), it is further judged that if the packet identification of said transport packet is in the useful packet identification list (step S550); if it is, it is judged that if there is another transport packet to be processed (step S590) after sending said transport packet to the output buffer (step S552); if not, the packet identification of said transport packet is set to be 0x1FFF, so that it is considered as a null packet (step S554); then after sending said null packet to the output buffer (step S556), it is judged that if there is another transport packet to be IS processed (step S590). Step S554 may also replace the relevant transport packet of program not selected by the user with a standard null packet, and then send said standard null packet to the output buffer.

Finally, if the judging result of said step S590 is that there is another transport packet to be processed, it returns to step S532 to repeat the above-mentioned loop, until there is no new transport packet to be processed, and then this flow ends.

The program associated table amendment in step S544 generally includes the following:

if the length of PAT changes, the “section length” field should be updated;

if the PAT table changes, the “CRC” field should be updated;

the entrance of the program not selected by the user should be canceled.

A specific example is provided in the following to illustrate how the program associated table is amended.

The original program associated table is as shown in Table 1. The length of the program associated table is 24 bytes and said table contains the program specific information of three programs, the “program_number” field is 0x0001, i.e., the PMT PID of program 1 is 0xA1; “program_number field is 0x0002, i.e., the PMT PID of program 2 is 0x00A2; “program_number field is 0x0003, i.e., the PMT PID of program 2 is 0x00A3. The content of the “section_length” field is 21. The cyclic redundancy check (CRC) field is calculated according to affix B of ISO/IEC13818-1 of MPEG-2 standard.

If the user selects program 1, the program associated table will be modified accordingly, the modified PAT is as shown in Table 2:

the fields of “program_number”, “reserved”, “program_map_Pld” of program 2 and program 3 should be canceled;

the content of “section_length” field should be modified to be 13;

the cyclic redundancy check (CRC) field is re-calculated on the basis of the modified PAT contents.

TABLE 1
PAT before amending

| Syntax | No. of bits | Mnemonic |
|---|---|---|
| program_association_section( ) | | |
| { | | |
| Table_id(0x00) | 8 | uimsbf |
| section_syntax_indicator | 1 | bslbf |
| ‘0’ | 1 | bslbf |
| reserved | 2 | bslbf |
| section_length(0x15 | 21 | uimsbf |
| hex) | | |
| transport_stream_id (0x 1F) | 16 | uimsbf |
| reserved | 2 | bslbf |
| version_number(0x00) | 5 | uimsbf |
| current_next_indicator | 1 | bslbf |
| Section_number | 8 | uimsbf |
| last_section_number | 8 | uimsbf |
| Program_number(0x0001) | 16 | uimsbf |
| Reserved | 3 | bslbf |
| program_map_PID(0xA1) | 13 | uimsbf |
| program_number(0x0002) | 16 | uimsbf |
| reserved | 3 | bslbf |
| program_map_PID(0xA2) | | uimsbf |
| program_number(0x0003) | 16 | uimsbf |
| reserved | 3 | bslbf |
| program_map_PID(0xA3) | | uimsbf |
| } | | |
| CRC_32 | 32 | rpchof |
| } | | |

TABLE 2
PAT after amending

| | No. of | |
|---|---|---|
| Syntax | bits | Mnemonic |
| program_association_section( ){ | | |
| table_id(0x00) | 8 | uimsbf |
| section_syntax_indicator | 1 | bslbf |
| ‘0’ | 1 | bslbf |
| reserved | 2 | bslbf |
| section_length(0x0D hex) | 13 | uimsbf |
| transport_stream_id ( 0x | 16 | uimsbf |
| 1F) | | |
| reserved | 2 | bslbf |
| version_number(0x00) | 5 | uimsbf |
| current_next_indicator | 1 | bslbf |
| section_number | 8 | uimsbf |
| last_section_number | 8 | uimsbf |
| program_number(0x0001) | 16 | uimsbf |
| Reserved | 3 | bslbf |
| program_map_PID(0xA1) | 13 | uimsbf |
| } | | |
| CRC_32 | 32 | rpchof |
| } | | |

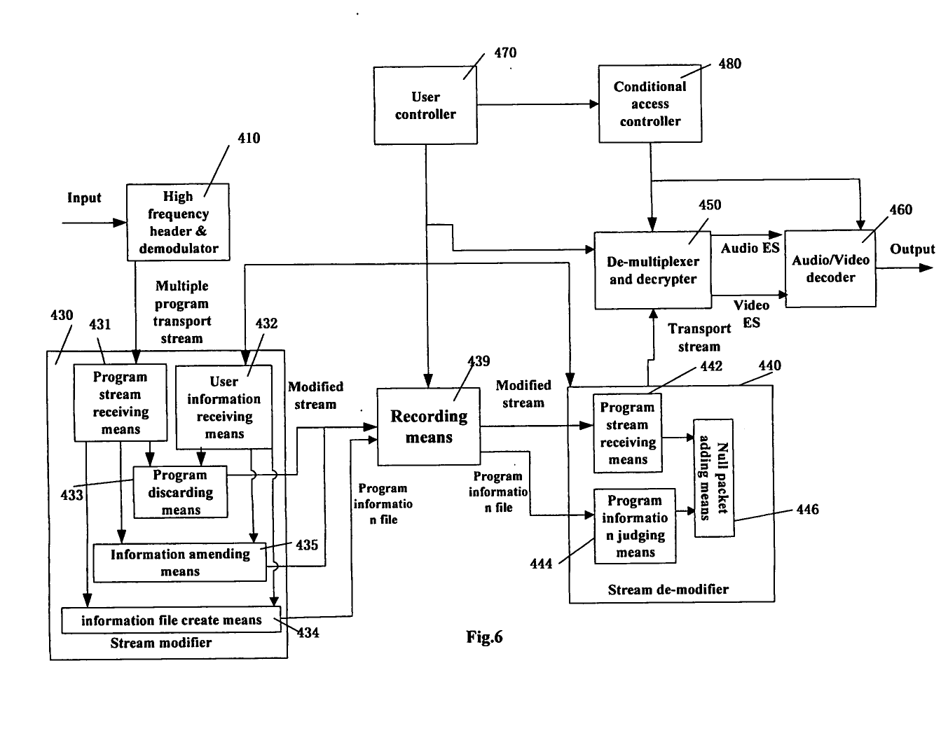

FIG. 6 is a schematic drawing of the system of storing/replaying specific program from an MPEG-2 multiple program transport stream according to another embodiment of the present invention. Said system of storing/replaying specific program differs from the system of extracting specific program of FIG. 4 by using a stream modifier 430, a recording means 439 and a stream de-modifier to replace the stream stuffer 420.

The stream modifier 430 comprises a program stream receiving means 431 for receiving a multiple program transport stream which comprises transport packets; a user information receiving means 432 for receiving the user selecting information for the specific program included in said multiple program transport stream; a packet discarding means 433 for discarding the transport packet of the non-user-selected program according to user selecting information for the specific program, and storing a null packet at said discarding position, the payload of said null packet contains a numerical value which may reflect the number of transport packets that are continuously discarded at said discarding position; and an information file generating means 434 for generating a program information file, which includes a packet discarding mark, said packet discarding mark is used to indicate that said program has been processed by packet discarding.

The stream modifier may also comprise an information amending means 435 for amending the program associated table of said program transport stream according to the user selecting information for specific program, and for storing a mark in a program information file at the same time, and said mark is used to indicate that the program associated table of said program has been amended.

The recording means 439 comprises a program storing means for storing all the un-discarded transport packets and said null packets and for storing said program information file.

The stream de-modifier 440 comprises a program stream receiving means 442 for reading each transport packet; a program information judging means 444 for reading the program information file stored in said storage medium and for judging if said program information file has packet discarding mark, and if it has, obtaining a numerical value in the payload of each null packet; a null packet adding means 446 for adding null packets with the number of said numerical value minus 1 beside said null packet. Said stream de-modifier 440 may also comprises a null packet judging means for judging if there is a numerical value in the payload of each null packet, if there is, obtaining said numerical value. Said null packet judging means may be included in said stream de-modifier 440 together with the program information judging means 444, or it may be used as substitution of the program information judging means 444 and included in said stream de-modifier 440 independently. In this case, the stream de-modifier 440 will no longer read the packet discarding mark from the program information file, but will directly judge each null packet to determine if the payloads thereof contain a numerical value.

When a multiple program transport stream is sent to the stream modifier 430, the program receiving means 431 thereof receives the transport packet in said transport stream, and the user information receiving means 432 thereof receives the control information for selecting specific program sent from the user controller 470 by the user, and based on said control information, the packet discarding means 433 thereof directly sends out the related transport packet of the program selected by the user; and discards the related transport packet of the non-user-selected program and add a null packet at each discarding position. The payload of said null packet contains numerical value 1, if a plurality of transport packets are discarded continuously, only one null packet needs to be added at said position, and the payload of said null packet contains a numerical value that may reflect the number of transport packets that are discarded continuously. These null packets as well as the transport packets that are not discarded in the original transport stream are outputted as modified stream. In addition, said information file generating means 434 may also generate a program information file, which contains a packet discarding mark for user in re-playing, and said packet discarding mark is used to indicate that packet discarding has been carried out in said program.

If there is one specific program selected by the user, the corresponding modified transport stream is a single program transport stream; if there are a plurality of specific programs selected by the user, the corresponding modified transport stream is a multiple program transport stream. The specific operation of said stream modifier 430 is described in the following.

The modified transport stream and program information file are recorded on the specified storage medium by the recording means 439. Said recording means may be a hard disc drive (HDD), an optical disc drive (CD or DVD), a magnetic tape drive or the other types of magnetic/optical storage.

When replaying the above recorded program, the user sends control information through the user controller 470, and the modified transport stream is read from the recording means 439 by the program receiving means of the stream de-modifier. The null packet judging means of the stream de-modifier 440 detects and judges each null packet, if the payload of said null packet contains a numerical value, said numerical value is obtained and null packets of the number of said numerical value minus 1 are added beside said null packet by the null packet adding means 446, and these null packets together with the non-null packets that are read out are send to the next step of processing, such as transferring or playing, as a transport stream in the order of reading and inserting. Said transport stream is a program transport stream conforming to MPEG-2 standard. Said processing will be described in detail below.

The above-mentioned transport stream is sent to the de-multiplexer and decrypter 450, and is decrypted and de-multiplexed into program elementary stream, such as audio elementary stream and video elementary stream, under the control of the user controller 470 and conditional access control 480, and said program elementary stream is further decoded by the audio/video decoder 460 into audio/video signal for play.

The user may also read out a program information file from the recording means 439, through the program information reading means 444 in the stream de-modifier 440, and the judging means judges that if said program information file has a packet discarding mark. If it has, the numerical value in the payload of the null packet is obtained to be processed by the null packet adding means 446.

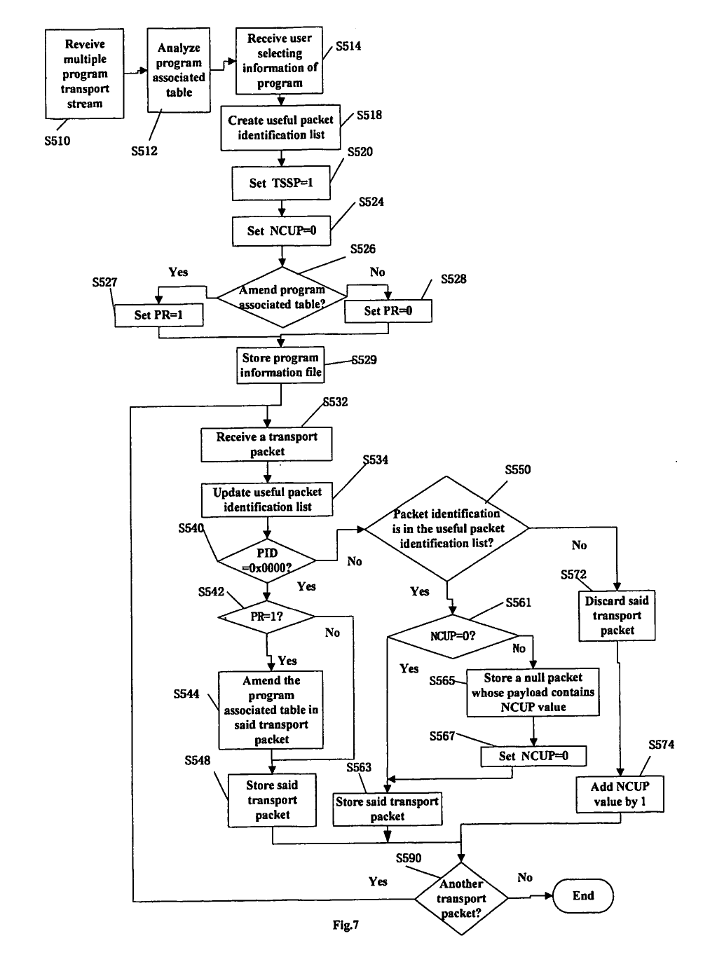

FIG. 7 is a schematic drawing of the flow of storing specific program from an MPEG-2 multiple program transport stream according to another embodiment of the present invention. Said flow is the specific operation process of the stream modifier 430 of FIG. 6. The steps before step S534 are substantially the same as the flow in FIG. 5, so they will not be repeated for the sake of conciseness. The difference is the addition of the step of setting the parameter TSSP to be 1 (step S520), setting parameter NCUP to be 0 (step S524), and storing program information file (step S529). Said parameter NCUP is used to mark the number of transport packets that are discarded continuously.

The program information file stored in step S529 includes at lest one packet discarding mark TSSP, for example, when TSSP equals to 1, said stored program stream has performed the packet discarding process. Said program information file may further include the program name and the modified stream recorded on the start and end positions, etc. of the storage medium. Said program information file may be stored at a predefined position of the storage medium. Likewise, the PR numerical value of the mark of amending the program associated table may also be stored in the program information file.

If the packet identification of the transport packet received in step S532 equals to 0x0000 (step S540), said transport packet contains the program associated table (PAT). It is judged that if the program associated table should be modified, according to whether PR equals to 1 (step S542), so that the generated new program transport stream may only reflect the selected specific program.

If PR equals to 1, the program associated table contained in said transport table (step S544) is amended as described previously, and it is judged that if there is another transport packet to be processed (step S590) after the modified transport packet is stored to the specified storage medium (step S548). If PR does not equal to 1, it is judged that if there is another transport packet to be processed (step S590), after said transport packet is directly stored into the specified storage medium (step S548). In this case, when displaying the program transport stream, the color of the title of the un-selectable program is set to be dark color at the application level, so as to allow the user to learn that the original program transport stream contains said un-selectable program.

If the packet identification of the transport packet received in step S532 does not equal to 0x0000 (step S540), it is further judged that if the packet identification of said transport packet is in the useful packet identification list (step S550). If it is, it is judged that if NCUP equals to 0 (step S561); if it does, said transport packet is stored into the specified storage medium (step S563); if not, a null packet is stored into the specified storage medium (step S565) and NCUP is set as 0 at the same time (step S567). The payload of said null packet contains a numerical value that may reflect the number of null packets that are discarded continuously, and then said transport packet is stored into the specified storage medium (step 563). In step S550, if the packet identification of said transport packet is not in the list of useful packet identification list, discarding said transport packet (step S572) and adding 1 to NCUP (step S574).

After finishing the above-mentioned process of storing or discarding, it is judged that if there is another transport packet to be processed (step S590). If there is another transport packet to be processed, return to step S532 to repeat the loop until there is no new transport packet to be processed, and then the process ends.

In the above step S565, a null packet is added at each of the discontinuous packet discarding position, whose payload contains a numerical value 1. If a plurality of transport packets are discarded continuously, only one null packet has to be added at said position, whose payload contains a numerical value which may reflect the number of the transport packets that are discarded continuously.

When storing the stuffed stream generated in the flow of FIG. 5, it is also feasible to discard all the null packets and store a null packet at the corresponding position of discarding. If only one null packet is discarded, the payload of the stored null packet contains a numerical value 1; if a plurality of transport packets are discarded continuously, only one null packet is stored, whose payload contains the number of transport packets that are continuously discarded at said position. Finally, a packet discarding mark is stored in a program information file on said storage medium, which mark indicates that packet discarding has been carried out in said program.

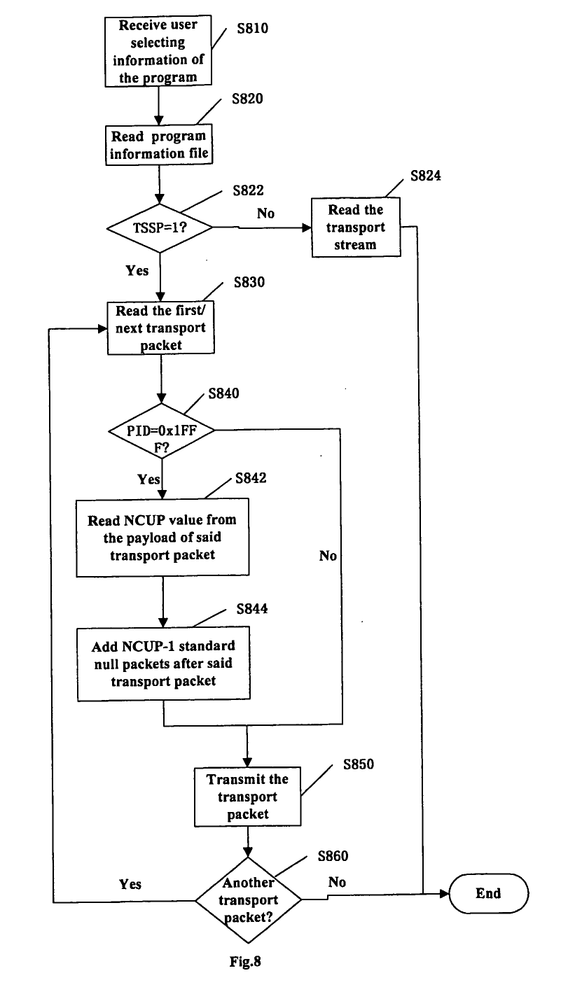

FIG. 8 is a schematic drawing of the flow of replaying the specific program stored in the present invention according to another embodiment of the present invention. This flow is the embodiment of the detailed process of the stream de-modifier 440 of FIG. 6 converting the received program stream into program transport stream compatible with MPEG-2 standard. First, the control information for selecting and replaying specific program sent by the user through the user controller 470 is received (step S810), the program information file is read out from the storage medium (step S820), the next step is decided on the basis that if the packet discarding mark TSSP of said program information file equals to 1 (step S822), the program transport stream on the storage medium is directly read out, to send it to the next step of processing, if TSSP does not equals to 1; and if TSSP equals to 1, it indicates that packet discarding has been carried out in said transport stream, thus each transport packet of the program stream on the storage medium is read out, to be processed by the steps described below (step S830).

If the packet identification PID of the transport packet read out equals to 0x1FFF (step S840), the NCUP numerical value is read from the payload of said transport packet (step S842), and NCUP minus 1 standard null packets are added beside said transport packet (step S844), and the word “beside” refers to the position of the previous or next position that is adjacent to said transport packet, then these null packets are sent to the next step of processing (step S850), such as playing or transferring. If the packet identification PID of the transport packet read out does not equal to 0x1FFF (step S840), said transport packet is directly sent to the next step of processing (step S850), such as playing or transferring. After finishing said sending step, it is judged that if there is another transport packet to be processed (step S860). and if there is, return to step S830 to repeat said loop until there is no new transport packet to be processed and then finish said flow.

In the above-described flow, steps S820, S822 and S824 may also be omitted, and a detecting and judging step may be added between step S840 and step S842, which detects and judges if the payload of the null packet has a numerical value; if there is, step S842 and step S844 will be carried out and then go to step S850; if not, directly jump to step S850.

In addition, the stream de-modifier 440 may also amend the program associated table (PAT) of the sent transport stream, so as to reflect the program content that may be selected actually in said program transport steam.

While the invention has been described in conjunction with specific embodiments, it is evident that many alternatives, amendments and variations will be apparent to those skilled in the art in light of the foregoing description. Accordingly, it is intended to embrace all such alternatives, amendments and variations that fall into the spirit and scope of the appended claims.

Although the present invention has been described in combination with a particular embodiment, according to the previous description, however, various alternatives, modifications and changes will be apparent for those skilled in the art. Therefore, the present invention will include all the alternatives, modifications and changes falling within the spirit and scope of appended claims.

1. A method for extracting a specific program(s) from a MPEG multiple program transport stream, comprising the steps of:
a. receiving a multiple program transport stream which includes transport stream packets;
b. receiving the user selecting information for the specific program(s) contained in the multiple program transport stream;
c. finding the transport stream packets of the non-user-selected program from the multiple program transport stream according to the user selecting information for the specific program(s);
d. setting the packet identifiers (PID) of the transport stream packets of the non-user-selected program into a specific value, which is the value of a null packet identifier.

2. The method according to claim 1, wherein said specific value as the null packet identifier is Ox1FFF (hexadecimal).

3. The method according to claim 1, wherein step c comprises the steps of:
finding the packet identifiers of the related transport stream packets from the program associated table according to the user selecting information for the specific program(s), the transport stream packets contain the program mapping table for the selected program;
finding the packet identifiers of the transport stream packets related to the selected program from said program mapping table, and creating a packet identifiers list of the user selected program; and
comparing the received packet identifiers of the transport stream packets with the packet identifiers in the packet identifiers list of the user selected program, to find out the transport stream packets of the non-user-selected program.

4. The method according to claim 1, further comprises the step of:
e. amending the program associated table of the multiple program transport stream according to the user selecting information for the specific program(s).

5. A system for selecting a specific program(s) from a MPEG multiple program transport stream, comprising:
a program stream receiving means for receiving a multiple program transport stream which includes a transfer steam packet;
a user information receiving means for receiving the user selecting information for the specific program(s) contained in the multiple program transport stream;
transport stream packets identifying means for finding out the transport stream packets of the non-user-selected program from the multiple program transport stream according to the user selecting information for the specific program(s);
a null packet setting means for setting the packet identifiers (PID) of the transport stream packets of the non-user-selected program into a specific value, which is the value of a null packet identifier.

6. The system according to claim 5, wherein the specific value as the null packet identifier is 0x1FFF (hexadecimal).

7. The system according to the 5, wherein the transport stream packets identifying means comprises:
a program finding means for finding the packet identifiers of the related transport stream packets from the program associated table according to the user selecting information for the specific program(s); the transport stream packets contain the program mapping table of the selected program;
a packet identifiers finding means for finding the packet identifiers of the transport stream packets related to the selected program from said program mapping table, and creating a packet identifiers list of the user selected program;
a packet identifiers comparing means for comparing the received packet identifiers of the transport stream packets with the packet identifiers in said packet identifiers table of the user selected program, to find out the transport steam packet of the non-user-selected program.

8. The system according to claim 5, further comprises:
an information amending means for amending the program associated table of the multiple program transport stream according to the user selecting information for the specific program(s).
